(19) United States
(12) Patent Application Publication
(10) Pub. No.: US 2004/0170833 A1
(43) Pub. Date: Sep. 2, 2004

(54) Methods of coating glass using epoxy resin compositions, glass materials coated therewith and composite materials containing the same

(76) Inventors: Rainer Hoefer, Duesseldorf (DE); Ulrich Nagorny, Hilden (DE); Thorsten Roloff, Duesseldorf (DE)

Correspondence Address: COGNIS CORPORATION, PATENT DEPARTMENT, 300 BROOKSIDE AVENUE, AMBLER, PA, 19002, US

(21) Appl. No.: 10/727,727

(22) Filed: Dec. 3, 2003

(30) Foreign Application Priority Data
Dec. 5, 2002 (DE) 102 56 883.9

(51) Int. Cl. B05D 3/02; D02G 3/00

(52) U.S. Cl. 428/375; 427/386

(57) ABSTRACT

Methods of coating glass with coating compositions comprising an epoxy resin reaction product of epichlorohydrin and a component selected from the group consisting of bisphenol A and bisphenol F in an amount of from 1 to 98% by weight, a water-dilutable epoxy resin hardener in an amount of from 1 to 98% by weight and water in an amount of from 1 to 98% by weight, are described along with methods of reinforcing synthetic fibers and composite materials including such coated glass.

### BACKGROUND OF THE INVENTION

European Patent Publication No. 0137427A describes sizing preparations for glass fibers consisting essentially of coupling agents, film formers and optionally lubricants, wetting agents and other additives known per se. The sizes additionally contain water-insoluble or water-dispersible masked polyisocyanates.

### SUMMARY OF THE INVENTION

The problem addressed by the present invention was to provide substances or compositions which would be suitable for coating glass and especially glass fibers.

The present invention relates to the use of epoxy resins in the form of reaction products of bisphenol A and/or bisphenol F with epichlorohydrin for coating glass.

The present invention also relates to the use of aqueous two-component coating compositions containing:

A) 1 to 98% by weight epoxy resins in the form of reaction products of bisphenol A and/or bisphenol F with epichlorohydrin,

B) 1 to 98% by weight water-dilutable epoxy resin hardeners and W)

1 to 98% by weight water; for coating glass. In one embodiment, the glass to be coated consists of glass fibers.

The present invention also relates to coated glass fibers obtainable by contacting an aqueous two-component coating composition containing:

A) 1 to 98% by weight epoxy resins in the form of reaction products of bisphenol A and/or bisphenol F with epichlorohydrin,

B) 1 to 98% by weight water-dilutable epoxy resin hardeners and

W) 1 to 98% by weight water;

with the surface of the glass fibers and then curing the coating composition.

The present invention also relates to the use of coated glass fibers obtainable as just described for reinforcing synthetic fibers.

In another embodiment, the present invention relates to a composite material containing coated glass fibers obtainable as described above.

It is specifically pointed out that individual species or mixtures of such species may be used for components A) and B). In other words, both one and also several epoxy resins A) or epoxy resin hardeners B) may be used.

The percentages by weight mentioned for components A) and B) are always based on the respective active substance contents. If, for example, an aqueous two-component coating composition is prepared by using one or more components in a water-based supply form, it is the quantity of active substance present in the individual components and not whether certain components were used in water-free or water-containing form in the production of the coating composition which is crucial to characterization of the composition of the two-component coating composition as a whole. Accordingly, the percentage content of component W), i.e. water, is always the sum total of water present in the coating composition as a whole.

### DETAILED DESCRIPTION OF THE INVENTION

Component A)

Component A) of the coating compositions according to the invention consists of epoxy resins in the form of reaction products of bisphenol A and/or bisphenol F with epichlorohydrin. Such reaction products are known to the expert (cf. for example DE-A-199 54 828).

The liquid unmodified bisphenol A or bisphenol F epoxy resins are solventless, easy to process and typically have viscosities in the range from 5,000 to 15,000 mPas and preferably in the range from 5,000 to 10,000 mpas (both here and in the following, the viscosities were measured at 20° C. using a Brookfield viscosimeter). They are commercially available. If desired, the viscosity of such resins can be further reduced, for example to 200 mPas, by addition of reactive diluents.

In one embodiment, epoxy resins of the above-mentioned type (reaction products of bisphenol A and/or bisphenol F with epichlorohydrin) which are liquid at 20° C. are used as component A).

Epoxy resins liquid at 20° C. in the form of reaction products of bisphenol A with epichlorohydrin are preferably used as component A).

Component B)

Component B) of the coating compositions according to the invention is a water-dilutable epoxy resin hardener. Compounds derived from adducts based on α,β-unsaturated carboxylic acid esters and mono-, di- or polyaminopolyalkylene oxide compounds are preferably used as component B). The compounds B) are preferably selected from the group of types B1) to B3) described hereinafter.

Hardeners of the B1) type are obtainable by:

(a) reacting one or more α,β-unsaturated carboxylic acid esters (I)

R²R³C═C(R⁴)COOR¹ (I)

where R¹ is an aromatic or aliphatic radical containing up to 15 carbon atoms, the substituents R², R³ and R⁴ independently of one another represent hydrogen, branched or unbranched, aliphatic or aromatic groups containing up to 20 carbon atoms or a group —(CH₂)ₙ—COOR¹, where R¹ is as defined above and n is a number of 0 to 10, in the presence of a transesterification catalyst with

(b) one or more hydroxy compounds, compounds (a) and (b) being used in such quantities that the equivalent ratio of the hydroxyl groups in (b) to the ester groups COOR¹ in the α,β-unsaturated carboxylic acid esters (a) is in the range from 1.5:1 to 10:1;

reacting this intermediate product Z1 obtained with

(c) one or more mono-, di- or polyaminopolyalkylene oxide compounds, an equivalent ratio of the reactive hydrogen atoms at the aminonitrogen atoms of (c) to the ester groups in the intermediate compound Z1 in the range from 10:1 to 1:10 being adjusted;

subsequently reacting this intermediate product Z2 obtained with

(d) one or more polyepoxides, the equivalent ratio of oxirane rings in polyepoxide (d) to reactive hydrogen atoms of the mono-, di- or polyaminopolyalkylene oxide compounds used in (c) being adjusted to a value of 100:1 to 1.5:1,

and subsequently reacting this intermediate product Z3 obtained with (e) one or more primary and/or secondary amines, the equivalent ratio of oxirane rings in the intermediate product Z3 to the reactive H atoms at the aminonitrogen atoms of (e) being adjusted to a value of 1:1.5 to 1:20.

The hardeners according to the invention are either liquid or solid substances, depending on their molecular weight.

The expression “equivalent ratio” is familiar to the expert. The basic concept behind the notion of the equivalent is that, for every substance participating in a reaction, the reactive groups involved in the desired reaction are taken into consideration. By indicating an equivalent ratio, it is possible to express the ratio which all the various reactive groups of the compounds (x) and (y) used bear to one another. It is important in this connection to bear in mind that a reactive group is understood to be the smallest possible reactive group, i.e. the notion of the reactive group is not identical with the notion of the functional group. In the case of H-acid compounds, this means for example that, although OH groups or NH groups represent such reactive groups, NH₂ groups with two reactive H atoms positioned at the same nitrogen atom do not. In their case, the two hydrogen atoms within the functional group NH2 are appropriately regarded as reactive groups so that the functional group NH2 contains two reactive groups, namely the hydrogen atoms.

In one embodiment, the intermediate compound Z1 and the compound (c) are used in such quantities that the equivalent ratio of reactive hydrogen atoms at the aminonitrogen atoms of (c) to the ester groups in the intermediate compound Z1 is in the range from 4:1 to 1:4 and more particularly in the range from 2.5:1 to 1.5:1.

In another embodiment, the equivalent ratio of oxirane rings in the polyepoxide (d) to reactive hydrogen atoms of the mono-, di- or polyaminopolyalkylene oxide compounds used in (c) is adjusted to a value in the range from 50:1 to 10:1.

Examples of the α,β-unsaturated carboxylic acid esters (a) corresponding to formula (I) to be used in accordance with the invention are methyl acrylate, ethyl acrylate, dimethyl maleate, diethyl maleate, dimethyl fumarate, di ethyl fumarate, dimethyl itaconate, di ethyl itaconate. Particularly preferred compounds (a) are dialkyl maleates, more particularly diethyl maleate and dimethyl maleate.

The hydroxy compounds (b) may be aliphatic or aromatic. The compounds (b) should be inert to transesterification catalysts. Examples of suitable aromatic compounds (b) are resorcinol, hydroquinone, 2,2-bis-(4-hydroxyphenyl)-propane (bisphenol A), isomer mixtures of dihydroxydiphenyl methane (bisphenol F), tetrabromobisphenol A, 4,4′-dihydroxydiphenyl cyclohexane, 4,4′-dihydroxy-3,3-dimethyldiphenyl propane, 4,4′-dihydroxydiphenyl, 4,4′-dihydroxybenzophenol, bis-(4-hydroxyphenyl)-1,1-ethane, bis-(4-hydroxyphenyl)-1,1 -isobutane, bis-(4-hydroxyphenyl)-methane, bis-(4-hydroxyphenyl)-ether, bis-(4-hydroxyphenyl)-sulfone etc. and the chlorination and bromination products of the above-mentioned compounds. Bisphenol A is the preferred aromatic compound (b).

In one preferred embodiment, the hydroxy compounds (b) are selected from the class of fatty alcohols, alkanediols and polyetherdiols. If desired, these compounds may also be alkoxylated.

The fatty alcohols are primary alcohols containing 6 to 36 carbon atoms which may be saturated or olefinically unsaturated. Examples of suitable fatty alcohols are hexanol, heptanol, octanol, pelargonyl alcohol, decanol, undecanol, lauryl alcohol, tridecanol, myristyl alcohol, pentadecanol, palmityl alcohol, heptadecanol, stearyl alcohol, nonadecanol, arachidyl alcohol, heneicosanol, behenyl alcohol, tricosanol, lignoceryl alcohol, 10-undecanol, oleyl alcohol, elaidyl alcohol, ricinolyl alcohol, linoleyl alcohol, linolenyl alcohol, gadoleyl alcohol, arachidonyl alcohol, erucyl alcohol, brassidyl alcohol.

The alkanediols are compounds corresponding to the general formula HOCH₂—R⁵—CH₂OH, where R⁵ is a hydrophobic hydrocarbon radical which may be saturated or unsaturated, linear or branched and may also contain aromatic structural elements. Examples are hexane-1,6-diol, heptane-1,7-diol and octane-1,8-diol, polyoxytetramethylenediols—also known as polytetrahydrofurans—and the so-called dimerdiols. Dimer diols are most particularly preferred for the purposes of the present invention.

Dimerdiols are well-known commercially available compounds which are obtained, for example, by reduction of dimer fatty acid esters. The dimer fatty acids on which these dimer fatty acid esters are based are carboxylic acids which may be obtained by oligomerization of unsaturated carboxylic acids, generally fatty acids, such as oleic acid, linoleic acid, erucic acid and the like. The oligomerization is normally carried out at elevated temperature in the presence of a catalyst, for example of clay. The substances obtained—dimer fatty acids of technical quality—are mixtures in which the dimerization products predominate. However, small amounts of higher oligomers, more particularly the trimer fatty acids, are also present. Dimer fatty acids are commercially available products and are marketed in various compositions and qualities. Abundant literature is available on the subject of dimer fatty acids, cf. for example the following articles: Fette & Öle 26 (1994), pages 47-51; Speciality Chemicals 1984 (May Number), pages 17, 18, 22-24. Dimerdiols are well-known among experts, cf. for example a more recent article in which inter alia the production, structure and chemistry of the dimerdiols are discussed: Fat Sci. Technol. 95 (1993), No. 3, pages 91-94. According to the invention, preferred dimerdiols are those which have a dimer content of at least 50% and more particularly 75% and in which the number of carbon atoms per dimer molecule is mainly in the range from 36 to 44.

Polyetherdiols in the context of the present invention are diols corresponding to the general formula HOCH₂—R⁶CH₂OH, where R¹³ is a hydrophobic hydrocarbon radical which may be saturated or unsaturated, linear or branched and may also contain aromatic structural elements and in which one or more CH₂ units must each be replaced by an oxygen atom.

A particularly attractive class of polyetherdiols can be obtained by alkoxylation of alkanediols, such as ethane-1,2-diol, propane-1,3-diol, propane-1,2-diol, butane-1,4-diol, butane-1,3-diol, pentane-1,5-diol, hexane-1,6-diol, heptane-1,7-diol and octane-1,8-diol, polyoxytetramethylenediols (polytetrahydrofurans) and dimerdiols. The production of these alkoxylated diols is normally carried out as follows: in a first step, the required diol is contacted with ethylene oxide and/or propylene oxide and the resulting mixture is reacted in the presence of an alkaline catalyst at temperatures of 20 to 200° C. Addition products of ethylene oxide (EO) and/or propylene oxide (PO) onto the diol used are obtained in this way. The addition products are therefore EO adducts or PO adducts or EO/PO adducts with the particular diol; in the case of the EO/PO adducts, the addition of EO and PO may take place statistically or blockwise.

Suitable transesterification catalysts for the reaction of the compounds (a) and (b) are any transesterification catalysts known to the expert from the prior art. Examples of suitable catalysts are sodium methylate, dibutyl tin diacetate, tetraisopropyl orthotitanate. If desired, the catalysts may be deactivated after the transesterification although this is not absolutely essential.

Suitable amino components (c) are mono-, di- or polyaminopolyalkylene oxide compounds. By this is meant that these compounds contain, on the one hand, one two or more amino functions (NH or NH₂ functions) and, on the other hand, alkylene oxide units. The alkylene oxide units are, in particular, ethylene oxide, propylene oxide and butylene oxide, ethylene oxide and propylene oxide being particularly preferred. The compounds (c) are substances at least partly soluble in water at 20° C.

The production of the compounds (c) is known from the prior art and comprises the reaction of hydroxyfunctional compounds with alkylene oxides and subsequent conversion of the resulting terminal hydroxyl groups into amino groups.

So far as the reaction of hydroxyfunctional compounds with alkylene oxides is concerned, ethoxylation and propoxylation are of particular importance. The following procedure is usually adopted: in a first step, the required hydroxyfunctional compounds are contacted with ethylene oxide and/or propylene oxide and the resulting mixture is reacted in the presence of an alkaline catalyst at temperatures in the range from 20 to 200° C. Addition products of ethylene oxide (EO) and/or propylene oxide (PO) are obtained in this way. The addition products are preferably EO adducts or PO adducts or EO/PO adducts with the particular hydroxyfunctional compound. In the case of the EO/PO adducts, the addition of EO and PO may be carried out statistically or blockwise.

In one embodiment, substances with the general formula R⁸—O—R⁹—CH₂CH(R¹⁰)—NH₂ are used as the compounds (c). In this formula: R⁸ is a monofunctional organic group containing 1 to 12 carbon atoms which may be aliphatic, cycloaliphatic or aromatic; R⁹ is a polyoxyalkylene group made up of 5 to 200 polyoxyalkylene units, more particularly EO and/or PO units; R¹⁰ is hydrogen or an aliphatic radical containing up to 4 carbon atoms.

Particularly suitable representatives of the compounds (c) for the purposes of the present invention are the “Jeffamines” known to the expert which are commercially available substances. One example is “Jeffamine 2070” which, according to the manufacturer Texaco, is produced by reacting methanol with ethylene oxide and propylene oxide and then converting the terminal hydroxyl groups of the intermediate product initially obtained into amine groups (cf. WO 96/20971, page 10, lines 12-15).

The compounds (c) preferably have average molecular weights (number average Mn) of 148 to 5,000 and more particularly in the range from 400 to 2,000.

The epoxy compounds (d) are polyepoxides containing on average at least two epoxy groups per molecule. These epoxy compounds may be both saturated and unsaturated and aliphatic, cycloaliphatic, aromatic and heterocyclic and may also contain hydroxyl groups. They may also contain substituents which do not cause any troublesome secondary reactions under the mixing and reaction conditions, for example alkyl or aryl substituents, ether groups and the like. These epoxy compounds are preferably polyglycidyl ethers based on polyhydric, preferably dihydric, alcohols, phenols, hydrogenation products of these phenols and/or novolaks (reaction products of mono- or polyhydric phenols with aldehydes, more particularly formaldehyde, in the presence of acidic catalysts). The epoxy equivalent weights of these epoxy compounds are preferably between 160 and 500 and more preferably between 170 and 250. The epoxy equivalent weight of a substance is the quantity of the substance (in grams) which contains 1 mole of oxirane rings. Preferred polyhydric phenols are the following compounds: resorcinol, hydroquinone, 2,2-bis-(4-hydroxyphenyl)-propane (bisphenol A), isomer mixtures of dihydroxydiphenyl methane (bisphenol F), tetrabromobisphenol A, 4,4′-dihydroxydiphenyl cyclohexane, 4,4′-dihydroxy-3,3-dimethyldiphenyl propane, 4,4′-dihydroxydiphenyl, 4,4′-dihydroxybenzophenol, bis-(4-hydroxyphenyl)-1,1-ethane, bis-(4-hydroxyphenyl)-1,1-isobutane, bis-(4-hydroxyphenyl)-methane, bis-(4-hydroxyphenyl)-ether, bis-(4-hydroxyphenyl)-sulfone etc. and the chlorination and bromination products of the above-mentioned compounds. Bisphenol A is most particularly preferred.

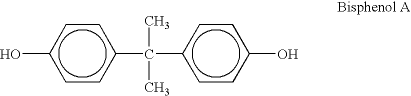

The polyglycidyl ethers of polyhydric alcohols are also suitable compounds (d). Examples of such polyhydric alcohols are ethylene glycol, diethylene glycol, triethylene glycol, 1,2-propylene glycol, polyoxypropylene glycols (n=1-20), 1,3-propylene glycol, 1,4-butylene glycol, pentane-1,5-diol, hexane-1,6-diol, hexane-1,2,6-triol, glycerol and bis-(4-hydroxycyclohexyl)-2,2-propane.

Other suitable compounds (d) are polyglycidyl ethers of polycarboxylic acids obtained by reaction of epichlorohydrin or similar epoxy compounds with an aliphatic, cycloaliphatic or aromatic polycarboxylic acid, such as oxalic acid, succinic acid, adipic acid, glutaric acid, phthalic acid, terephthalic acid, hexahydrophthalic acid, 2,6-naphthalenedicarboxylic acid and dimerized linolenic acid. Examples are adipic acid diglycidyl ester, phthalic acid diglycidyl ester and hexahydrophthalic acid diglycidyl ester.

A comprehensive list of suitable epoxy compounds (d) can be found in: A. M. Paquin, “Epoxidverbindungen und Epoxidharze”, Springer-Verlag, Berlin 1958, Chapter V, pages 308 to 461 and Lee, Neville “Handbook of Epoxy Resins” 1967, Chapter 2, pages 201 and 2-33.

Mixtures of several epoxy compounds (d) may also be used.

Amines (e) suitable for the purposes of the invention are primary and/or secondary amines. Preferred amines (e) are polyamines containing at least two nitrogen atoms and at least two active aminohydrogen atoms per molecule. Aliphatic, aromatic, aliphatic-aromatic, cycloaliphatic and heterocyclic di- and polyamines may be used.

The following are examples of suitable amines (e): polyethylene amines (ethylene diamine, diethylene triamine, triethylene tetramine, tetraethylene pentamine, etc.), 1,2-propylene diamine, 1,3-propylene diamine, 1,4-butane diamine, 1,5-pentane diamine, 1,3-pentane diamine, 1,6-hexane diamine, 3,3,5-trimethyl-1,6-hexanediamine, 3,5,5-trimethyl-1,6-hexane diamine, 2-methyl-1,5-pentane diamine, bis-(3-aminopropyl)-amine, N,N′-bis-(3-aminopropyl)-1,2-ethane diamine, N-(3-aminopropyl)-1,2-ethane diamine, 1,2-diaminocyclohexane, 1,3-diaminocyclohexane, 1,4-diaminocyclohexane, aminoethyl piperazines, the poly(alkylene oxide)diamines and triamines (such as, for example, Jeffamine D-230, Jeffamine D-400, Jeffamine D-2000, Jeffamine D-4000, Jeffamine T-403, Jeffamine EDR-148, Jeffamine EDR-192, Jeffamine C-346, Jeffamine ED-600, Jeffamine ED-900, Jeffamine ED-2001), meta-xylyene diamine, phenylene diamine, 4,4′-diaminodiphenyl methane, toluene diamine, isophorone diamine, 3,3′-dimethyl-4,4′-diaminodicyclohexyl methane, 4,4′-diaminodicyclohexylmethane, 2,4′-diaminodicyclohexyl methane, the mixture of poly(cyclohexylaromatic)amines attached by a methylene bridge (also known as MBPCAA) and polyaminoamides.

Other suitable compounds (e) are the reaction products of the amines just mentioned with the above-described α,β-unsaturated carboxylic acid esters (a) and the reaction products of the amines just mentioned with the above-described polyepoxy compounds (d).

Hardeners of the B2) type are obtainable by:

(a) reacting one or more α,β-unsaturated carboxylic acid esters (I):

R²R³C═C(R⁴)COOR¹ (I)

where R¹ is an aromatic or aliphatic radical containing up to 15 carbon atoms, the substituents R², R³ and R⁴ independently of one another represent hydrogen, branched or unbranched, aliphatic or aromatic groups containing up to 20 carbon atoms or a group —(CH₂)ₙ—COOR¹, where R¹ is as defined above and n is a number of 0 to 10, with

(c) one or more mono-, di- or polyaminopolyalkylene oxide compounds, compounds (a) and (c) being used in such quantities that the equivalent ratio of the reactive hydrogen atoms at the aminonitrogen atoms of (c) to the C═C double bond in the α,β-position to the group COOR¹ shown in formula (I) in the carboxylic acid esters (a) is in the range from 10:1 to 1:10;

subsequently reacting this intermediate product Z4 obtained with

(d) one or more polyepoxides, the equivalent ratio of oxirane rings in polyepoxide (d) to reactive hydrogen atoms in the mono-, di- or polyaminopolyalkylene oxide compounds (c) being adjusted to a value of 100:1 to 1.5:1;

and subsequently reacting this intermediate product Z5 obtained with

(e) one or more primary and/or secondary amines, the equivalent ratio of oxirane rings in the intermediate product Z5 to the reactive H atoms at the aminonitrogen atoms of (e) being adjusted to a value of 1:1.5 to 1:20.

The foregoing observations on hardeners of the B1) type otherwise apply to the substances (a) and to the substances (c) to (e).

Hardeners of the B3) type are obtainable by:

(a) reacting one or more α,β-unsaturated carboxylic acid esters (I):

R²R³C═C(R⁴)COOR¹ (I)

where R¹ is an aromatic or aliphatic radical containing up to 15 carbon atoms, the substituents R², R³ and R⁴ independently of one another represent hydrogen, branched or unbranched, aliphatic or aromatic groups containing up to 20 carbon atoms or a group —(CH₂)ₙ—COOR¹, where R¹ is as defined above and n is a number of 0 to 10, with;

(c) one or more mono-, di- or polyaminopolyalkylene oxide compounds, compounds (a) and (c) being used in such quantities that the equivalent ratio of the reactive hydrogen atoms at the aminonitrogen atoms of (c) to the C═C double bond in the α,β-position to the group COOR¹ shown in formula (I) in the carboxylic acid esters (a) is in the range from 10:1 to 1:10,

subsequently reacting this intermediate product Z4 obtained with

(g) one or more polyhydroxy compounds, the equivalent ratio of ester groups in the intermediate compound Z4 to hydroxy groups in the polyhydroxy compound (g) being adjusted to a value of 1:1.1 to 1:10,

and subsequently reacting this intermediate product Z6 obtained with

(d) one or more polyepoxides, the equivalent ratio of oxirane rings in polyepoxide (d) to hydroxyl groups in the intermediate product Z6 being adjusted to a value of 1.5:1 to 6:1,

and subsequently reacting this intermediate product Z7 obtained with

(e) one or more primary and/or secondary amines, the equivalent ratio of oxirane rings in the intermediate product Z7 to the reactive H atoms at the aminonitrogen atoms of (e) being adjusted to a value of 1:1.5 to 1:20.

The foregoing observations on hardeners of the B1) type otherwise apply to the substances (a) and to the substances (c) to (e).

The polyhydroxy compounds (g) may be aliphatic or aromatic. In one embodiment, the polyhydroxy compounds (g) are selected from the class of special aliphatic diols, namely alkanediols, especially dimer diols, polyether diols and polyester diols. The foregoing observations on hardeners of the B1) type in relation to component (b) apply to the alkanediols, including the dimerdiols, and the polyether diols. Polyesterdiols in the context of the invention are diols corresponding to the general formula HOCH₂—R⁷—CH₂OH, where R⁷ is a hydrophobic hydrocarbon radical which may be saturated or unsaturated, linear or branched and may also contain aromatic structural elements and in which one or more CH₂ units must each be replaced by a COO unit. They are normally produced by reacting difunctional polyols with dicarboxylic acids or anhydrides thereof Commonly used polyols are ethylene glycol, propane-1,2-diol, butane-1,4-diol, hexane-1,6-diol. Typical dicarboxylic acids are succinic acid, adipic acid, phthalic anhydride. Hexane-1,6-diol adipic acid polyesters are particularly preferred.

Other Components

Besides the compulsory components A), B) and W) already mentioned, other additives may also be used—if desired—in the two-component coating compositions according to the invention. Examples of such additives include lubricants, plasticizers, antistatic agents, coupling agents, fillers, wetting agents and defoamers. In this case, the proviso applies that the sum total of all components of the two-component coating compositions, i.e. the sum of components A), B), W) and the other additives required, should come to 100% by weight.

### EXAMPLES

Substances Used:

Epoxy Resins According to the Invention

Chem-Res E 20: liquid epoxy resin based on bisphenol A/F; H equivalent=190 (Cognis S.p.A./Italy)

Chem-Res E 50: epoxy resin based on bisphenol A/F, 75% by weight in toluene; H equivalent=475 (Cognis S.p.A./Italy)

Hardeners

Waterepoxy 751: amine-based hardener for epoxy resins (Cognis Deutschland GmbH & Co. KG/Germany).

Waterepoxy 603: polyamidoamine-based hardener for epoxy resins; 100 parts contain 50 parts by weight hardener and 50 parts by weight water; amine equivalent=190 (Cognis Deutschland GmbH & Co. KG/Germany).

Versamid 225: commercially available polyamide-based hardener for epoxy resins; 100 parts contain 60 parts by weight hardener, 32 parts by weight xylene and 8 parts by weight n-butanol; amine equivalent=95.

Testing of Peel Strength

(to ISO 7004/DIN 53539)

Glass test specimens measuring 25×66×3 mm were degreased with acetone and dried. The test specimens were then coated on one surface with a mixture of epoxy resin and hardener using a film drawing knife (type 360, Erichsen/Sundwig). The coating thickness was 25 micrometers. The two components (epoxy resin and hardener) of the above-mentioned mixture were present in the exact stoichiometric mixing ratio, i.e. an equivalent ratio of 1:1.

After curing for 24 hours at 23° C., a commercially available two-component epoxy resin adhesive (Metallon FL, a product of Henkel KGAA, Düsseldorf) was applied to the coating of the glass test specimens. A strip of cloth (material: Mantelpopeline, polyester/cotton (67:33) blend; size of the strip: 25×195 mm) was then placed on the adhesive and held in place with clips. The test specimen thus prepared was then left for 7 days at 23° C., after which peel strength in N/mm² was determined by peeling off the strip of cloth using a Zwick tensile testing machine.

The results of the various tests are set out in Table 1. The peel strengths shown are the averages of three measurements.

TABLE 1

| Resin | Hardener | Peel strength in N/mm² |
|---|---|---|
| Chem-Res E 20 | Waterpoxy 751 | 1.37 |
| Chem-Res E 20 | Waterpoxy 603 | 1.99 |
| Chem-Res E 20 | Versamid 225 | 1.56 |
| Chem-Res E 20 | Versamid 225 | 1.20 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of coating a glass substrate, said method comprising:
(a) providing a glass substrate; and
(b) contacting the glass substrate with a coating composition comprising an epoxy resin reaction product of epichlorohydrin and a component selected from the group consisting of bisphenol A and bisphenol F.

2. The method according to claim 1, wherein the coating composition further comprises a water-dilutable epoxy resin hardener in an amount of from 1 to 98% by weight and water in an amount of from 1 to 98% by weight, and wherein the epoxy resin reaction product is present in an amount of from 1 to 98% by weight.

3. The method according to claim 1, wherein the epoxy resin reaction product is liquid at 20° C.

4. The method according to claim 1, wherein the epoxy resin reaction product comprises a reaction product of epichlorohydrin and bisphenol A.

5. The method according to claim 1, wherein the glass substrate comprises a glass fiber.

6. A coated glass fiber prepared by the process comprising:
(a) providing a glass fiber to be coated;
(b) providing a coating composition comprising an epoxy resin reaction product of epichlorohydrin and a component selected from the group consisting of bisphenol A and bisphenol F in an amount of from 1 to 98% by weight, a water-dilutable epoxy resin hardener in an amount of from 1 to 98% by weight and water in an amount of from 1 to 98% by weight; and
(c) contacting at least a portion of the glass fiber with the coating composition.

7. The coated glass fiber according to claim 6, wherein the epoxy resin reaction product is liquid at 20° C.

8. The coated glass fiber according to claim 6, wherein the epoxy resin reaction product comprises a reaction product of epichlorohydrin and bisphenol A.

9. A method of reinforcing synthetic fiber, said method comprising:
(a) providing a synthetic fiber;
(b) providing a coated glass fiber according to claim 6; and
(c) combining the synthetic fiber and the coated glass fiber.

10. A composite material comprising a coated glass fiber according to claim 6 and one or more other materials or fillers.
